(19) United States
(12) Patent Application Publication
(10) Pub. No.: US 2004/0068363 A1
(43) Pub. Date: Apr. 8, 2004

(54) Client-server vehicle data communication system and server and client terminal of the system

(75) Inventor: Shinichiro Goto, Haga-gun (JP)

Correspondence Address: ARENT FOX KINTNER PLOTKIN & KAHN, PLLC, Suite 400, 1050 Connecticut Avenue, N.W., Washington, DC, 20036-5339, US

(73) Assignee: HONDA MOTOR CO., LTD.

(21) Appl. No.: 10/678,136

(22) Filed: Oct. 6, 2003

(30) Foreign Application Priority Data
Oct. 8, 2002 (JP) 2002-295143

(51) Int. Cl. G01C 21/28

(52) U.S. Cl. 701/200

(57) ABSTRACT

A client-server vehicle data communication system for efficiently updating service contents stored in the client terminal and minimizing wasted time and cost for communication. A server of the system has a service contents managing section for managing a plurality of service contents to be provided to a client terminal of a vehicle. The service contents managing section includes a cache identifier providing section for assigning each service content provided to the client terminal a cache identifier which indicates a data cache state in the client terminal, so as to manage the data cache state of the service content. The client terminal has a cache state managing section for managing the data cache state of the service content provided from the server, according to the cache identifier assigned to the service content.

### BACKGROUND OF THE INVENTION

1. Field of the Invention

The present invention relates to a server of a client-server vehicle data communication system, a client terminal of a vehicle, and a client-server vehicle data communication system employing such a server and client terminal.

2. Description of the Related Art

Recently, various techniques relating to data handling in a client-server vehicle data communication system (which is established via a network) have been proposed.

For example, Japanese Unexamined Patent Application, First Publication No. 2001-325280 (refer to paragraphs [0009] and [0010], and FIG. 1) discloses a technique in which only a relatively large amount of data (e.g., image data) are stored in a client terminal, thereby reducing the load imposed on a communication line.

However, the value of data to be stored does not always correspond to the kind of data (e.g., image data) and is determined depending on the content of the data. Therefore, even when the kinds of data are the same, the necessity for updating the data is different and determined depending on the content of the data. In the conventional technique, even data having a low necessity for data update may be repeatedly accessed and obtained, or data having a high necessity for data update may not be accessed and obtained for a long time. In particular, such problems are noticeable in the client terminal of a vehicle, which has a limited data storage capacity.

### SUMMARY OF THE INVENTION

In consideration of the above circumstances, an object of the present invention is to provide a server of a client-server vehicle data communication system and a client terminal of a vehicle for efficiently updating service contents stored in the client terminal and minimizing wasted time and cost for communication, and a client-server vehicle data communication system employing such a server and client terminal.

Therefore, the present invention provides a server of a client-server vehicle data communication system, comprising:

a service contents managing section (e.g., a contents managing section 11 in an embodiment explained below) for managing a plurality of service contents to be provided to a client terminal (e.g., a client terminal 4 in the embodiment) of a vehicle, wherein the service contents managing section includes a cache identifier providing section for assigning each service content provided to the client terminal a cache identifier which indicates a data cache state in the client terminal, so as to manage the data cache state of the service content.

According to the above structure, the cache identifier is assigned to each service content by the service contents managing section according to the details or type of the service content; thus, the data cache state of the service content can be managed in the client terminal by referring to the cache identifier. Therefore, it is possible to control the frequency of update of the service content provided to the client terminal, according to the cache identifier. For example, a service content having a high necessity for data update may not be cached, and a service content having a low necessity for data update may be cached for a long time. Such control of the cache state is performed by the client terminal. Therefore, according to the type of each service content, the service content can be efficiently updated in the client terminal, thereby minimizing wasted time and cost for communication.

As a typical example, the assigned cache identifier is selected from the group consisting of:

an identifier for indicating that the service content is not stored in the client terminal (e.g., an identifier A in the embodiment);

an identifier for indicating that the service content is temporarily stored until an engine of the vehicle is stopped (e.g., an identifier D in the embodiment);

an identifier for indicating that the service content is stored even after the engine of the vehicle is stopped (e.g., an identifier E in the embodiment);

an identifier for indicating that the service content is stored while a travel distance of the vehicle from where the vehicle obtained the service content is within a predetermined value (e.g., an identifier C in the embodiment); and

an identifier for indicating that the service content is stored from when the vehicle obtains the service content until a predetermined time has elapsed (e.g., an identifier B in the embodiment).

According to this example, the data cache state of the service content can be managed in more detail, thereby improving the convenience of the system.

The present invention also provides a client terminal using a server (of a client-server vehicle data communication system) as explained above, the client terminal comprising:

a cache state managing section (e.g., a cache state managing section 17 in the embodiment) for managing the data cache state of the service content provided from the server, according to the cache identifier assigned to the service content.

According to this client terminal, the data cache state of each service content can be managed by the cache state managing section, according to the type of the cache identifier assigned by the server; thus, the frequency of update of the service content can be controlled according to the details or type of the service content. Therefore, according to the type of each service content, the service content can be efficiently updated, thereby minimizing wasted time and cost for communication.

The client terminal may further comprise:

a request sending section for sending a request signal for the service content to the server, where the service content is provided from the server when the request signal is received by the server;

the cache identifier indicates a condition for caching of the service content; and

when a request for the service content is again issued in the client terminal while the condition for the caching is satisfied and the service content is cached in a memory of the client terminal, the service content in the memory is read out without sending the request signal for the service content to the server.

The present invention also provides a client-server vehicle data communication system comprising a server as explained above and a client terminal as explained above.

According to this system, the service content can be efficiently updated in the client terminal according to the details or type of the service content, thereby minimizing wasted time and cost for communication.

In a preferable example of the client-server vehicle data communication system, the service content is provided from the server to the client terminal when a request signal for the service content is sent from the client terminal to the server;

the cache identifier indicates a condition for caching of the service content; and

when a request for the service content is again issued in the client terminal while the condition for the caching is satisfied and the service content is cached in a memory of the client terminal, the service content in the memory is read out without sending the request signal for the service content to the server.

The present invention also provides a client terminal of a vehicle for obtaining data provided from a server which manages a plurality of service contents, said client terminal comprising:

a cache state managing section for recognizing a cache identifier which indicates a data cache state of data of a service content obtained from the server and managing the data cache state indicated by the cache identifier.

### BRIEF DESCRIPTION OF THE DRAWINGS

FIG. 1 is a diagram showing the general structure of a client-server vehicle data communication system 1 in an embodiment according to the present invention.

FIG. 2 is a diagram showing the general structure of a server 2 in FIG. 1.

FIG. 3 is a diagram showing the general structure of a navigation device 4 in FIG. 1.

FIG. 4 is a timing chart of the operation between the server 2 and the navigation device 4 in FIG. 1.

FIG. 5 is also a timing chart of the operation between the server 2 and the navigation device 4 in FIG. 1.

FIG. 6 is also a timing chart of the operation between the server 2 and the navigation device 4 in FIG. 1.

FIG. 7 is also a timing chart of the operation between the server 2 and the navigation device 4 in FIG. 1.

FIG. 8 is also a timing chart of the operation between the server 2 and the navigation device 4 in FIG. 1.

### DESCRIPTION OF THE PREFERRED EMBODIMENTS

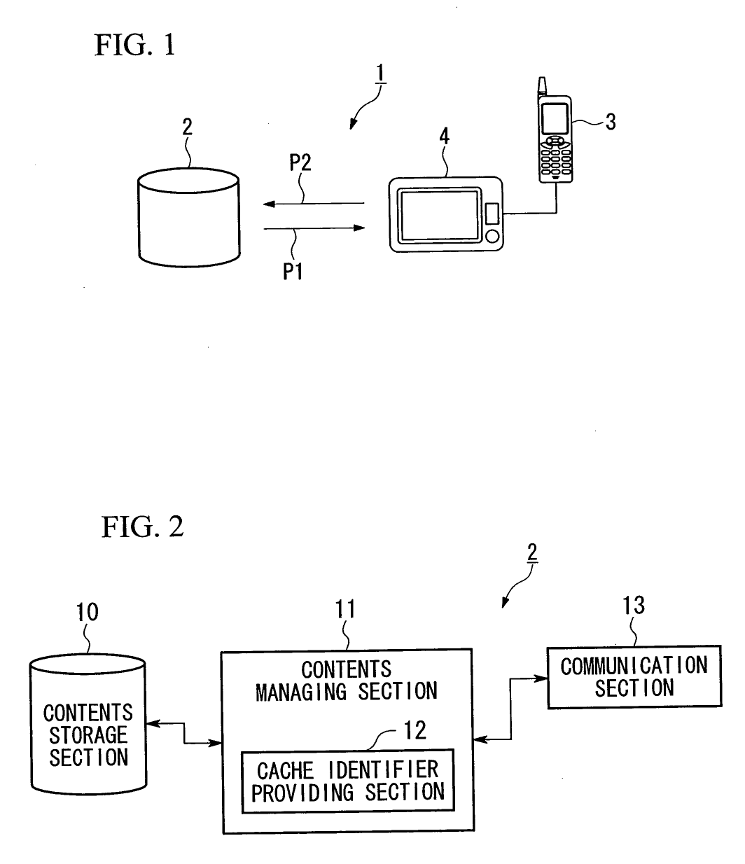

Hereinafter, the client-server vehicle data communication system as an embodiment according to the present invention will be explained with reference to the drawings. FIG. 1 is a diagram showing the general structure of a client-server vehicle data communication system 1 in the embodiment.

This communication system 1 has a server 2, a portable terminal 3, and a navigation device 4 (i.e., the client terminal) of a vehicle. The navigation device 4 connected to the portable terminal 3 can send and receive data to and from the server 2 via the portable terminal 3. More specifically, the client terminal 4 connected to the portable terminal 3 sends a data request signal for requesting data (stored in the server 2) to the server 2 (see arrow P2), and the server 2 sends a service content (i.e., service data), which is stored in the server, to the client terminal 4 according to the data request signal (see arrow P1).

FIG. 2 is a diagram showing the general structure of the server 2. The server 2 has a contents storage section 10, a contents managing section 11, and a communication section 13. The contents storage section 10 is a memory for storing various service contents to be provided to the client terminal 4. As explained below, the service contents are classified into categories and stored, where the categories are defined according to the necessity for data update (here, categories K1 to K5, which are not shown in FIG. 2).

The contents managing section 11 includes a cache identifier providing section 12 for providing a cache identifier. This cache identifier providing section 12 provides cache identifiers (here, identifier A to identifier E) corresponding to the categories (K1 to K5) for which the service contents are classified and stored. The cache state in the client terminal 4 is managed using the cache identifier.

The communication section 13 receives a data request signal from the client terminal 4 which is connected to the portable terminal 3, and according to a command from the contents managing section 11, the communication section 13 sends the client terminal 4 data of the service content, to which a cache identifier has been appended.

The server 2 also has a data storage section for storing speech recognition vocabulary data corresponding to each service content, and a read-out data converting section for converting the text data of the service content into read-out data for speech synthesis and outputting the data as a TTS (text-to-speech) file.

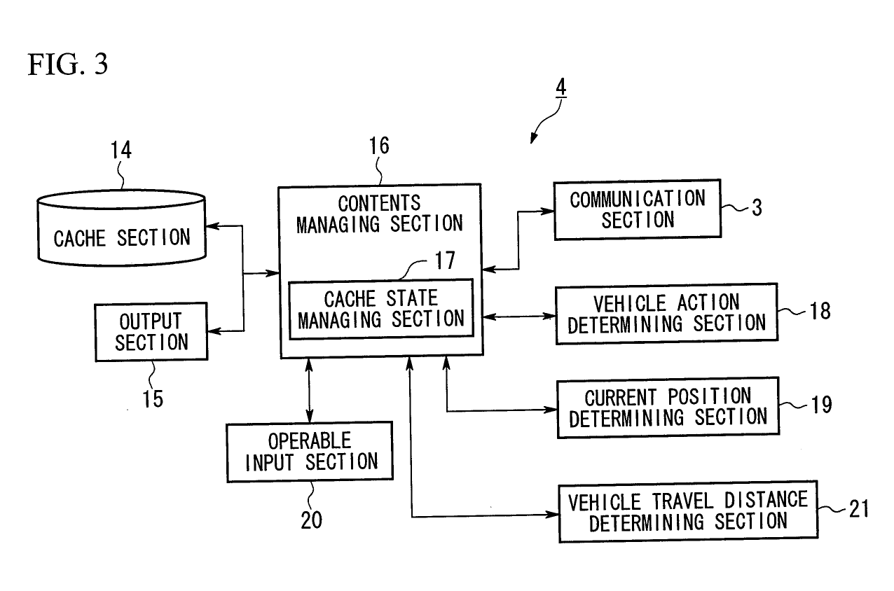

FIG. 3 is a diagram showing the general structure of the client terminal 4. The client terminal 4 has a communication section 3 (here, a portable terminal 3), a contents managing section 16, a cache section 14, and an output section 15 (here, a display section). The client terminal 4 also has a vehicle action determining section 18, a current position determining section 19, an operable input section 20, and a vehicle travel distance determining section 21.

The communication section 3 sends a data request signal to the communication section 13 of the server 2 and receives the service content sent from this communication section 13. The operable input section 20 is an input device which can be operated by a user (i.e., a passenger) in the vehicle. In the present embodiment, the operable input section 20 has a microphone, by which voice operation by the passenger is possible.

The vehicle action determining section 18 is used for determining whether the vehicle is currently operating. In the present embodiment, the determination is performed by referring to whether the ignition switch (IG) is operated (i.e., on) or stopped (i.e., off). The vehicle action determining section 18 also determines the action mode of the vehicle. According to the above determination, the input and output operation of the client terminal 4 is suitably limited, as explained below. The determination of the action mode of the vehicle can be performed, for example, by referring to the position of the shift lever (i.e., the shift position). That is, when the shift position is P (parking) or N (neutral), it is determined that the vehicle is in stop mode, while in the other positions, it is determined that the vehicle is in driving mode.

The current position determining section 19 is used for determining the current position of the vehicle, and the determination may be performed by using a GPS (global positioning system) function.

The vehicle travel distance determining section 21 is used for determining the travel distance of the vehicle. Here, the travel distance is determined based on the rotation speed of the wheels or the position data using the GPS function.

The contents managing section 16 has a cache state managing section 17. This cache state managing section 17 performs management of the cache state of each service content, which is provided from the server 2, based on the cache identifier assigned to the service content.

The cache section 14 is a memory in which each service content is stored (i.e., cached) according to an instruction from the contents managing section 16. This cache section 14 has both a rewritable volatile memory (RAM) and a non-rewritable nonvolatile memory (ROM). According to the instruction of the contents managing section 16, each service content is cached into one of the above ROM or RAM.

The output section 15 has a display for displaying the service content and another output device (here, speaker) for outputting a speech data file. The client terminal 4 includes speech vocabulary data for recognizing voice data input from the operable input section 20, and a conversion device for converting (or synthesizing) recognized speech data into a text file or converting the above-explained TTS file, sent from the server 2, into a speech data file.

The contents managing section 16 limits the input and output operation of the client terminal 4, according to the action mode of the vehicle. That is, when the vehicle is in stop mode, no specific limitation for input/output of the client terminal 4 is performed; however, when the vehicle is in driving mode, input/output of the client terminal 4 is limited to voice data. Accordingly, it is possible to improve the safety of the running vehicle.

Below, the cache identifier appended to each service content will be explained. The cache identifier in the present embodiment has the following types: (i) identifier A for indicating that the service content is not stored in the client terminal 4 (i.e., no caching), (ii) identifier B for indicating that the service content is stored from when the client terminal 4 obtains the service content until a predetermined time has elapsed (in the present embodiment, until a specific time has been reached), (iii) identifier C for indicating that the service content is stored while the travel distance of the vehicle is equal to or less than a predetermined value, (iv) identifier D for indicating that the service content is temporarily stored in the client terminal 4 until the engine of the vehicle is stopped, and (v) identifier E for indicating that the service content is stored even after the engine of the vehicle is stopped.

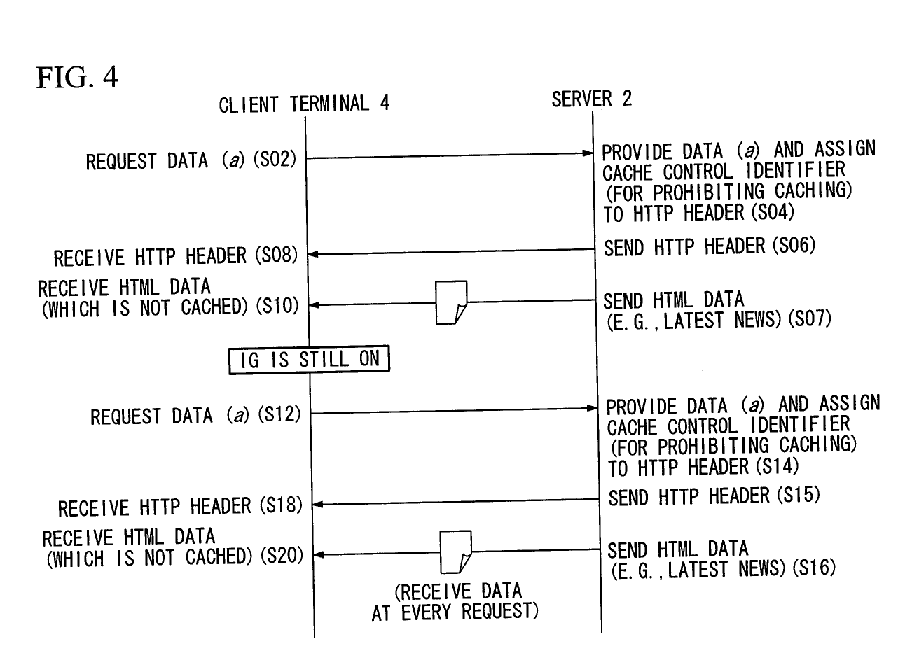

According to the contents (here, data a to data e) of the service contents, the cache identifier providing section 12 assigns one of the identifiers A to E to each service content, so as to manage the cache state in the client terminal 4. The data a to e will be explained below with reference to FIGS. 4 to 8.

FIGS. 4 to 8 are timing charts of the operation between the server 2 and the navigation device 4 in FIG. 1. FIG. 4 relates to a case in which a service content of the latest news (i.e., data a) is requested. When a passenger inputs a data access request for data a into the client terminal 4 via the operable input section 20, the client terminal 4 sends a service content request signal for data a from the communication section 3 (see step S02).

When the server 2 receives the request signal via the communication section 13, the contents managing section 16 reads out data a, which has been stored for the category K1 in the contents storage section 10, and converts the data into HTML (hypertext markup language) data.

In this process, cache identifier A (which prohibits caching) corresponding to the category K1 is assigned to the HTTP (hypertext transfer protocol) header of the HTML data by the cache identifier providing section 12 (see step S04). In steps S06 and S07, the HTTP header, to which the cache identifier A has been appended, and the HTML data for data a are sent to the client terminal 4.

In steps S08 and S10, the client terminal 4 receives the HTTP header and the HTML data via the communication section 3. The HTML data for data a is then output to the output section 15 (i.e., data is displayed or voice data is output) via the contents managing section 16. The cache state managing section 17 performs management of the cache state according to the cache identifier A appended to the received HTTP header. In this case, the HTML data of data a is not stored in the cache section 14. Therefore, when the image on a screen of the output section is changed by an operation of the passenger, or the like, the HTML data of data a is deleted without being stored.

When the service content request signal for data a is again sent to the server 2 while the ignition switch (IG) is still in the on-state (see step S12), the server 2 performs a similar operation as explained above, that is, assigns the cache identifier A to the HTTP header (see step S14) and sends the HTTP header and the HTML data of data a (see steps 15 and 16). The client terminal 4 receives these data (see steps S18 and S20). Similar to the above process, when the image on the screen of the output section is changed, the HTML data of data a is deleted without being stored. As explained above, this type of data, which should be frequently updated, is not cached and is obtained from the server 2 every time data is requested.

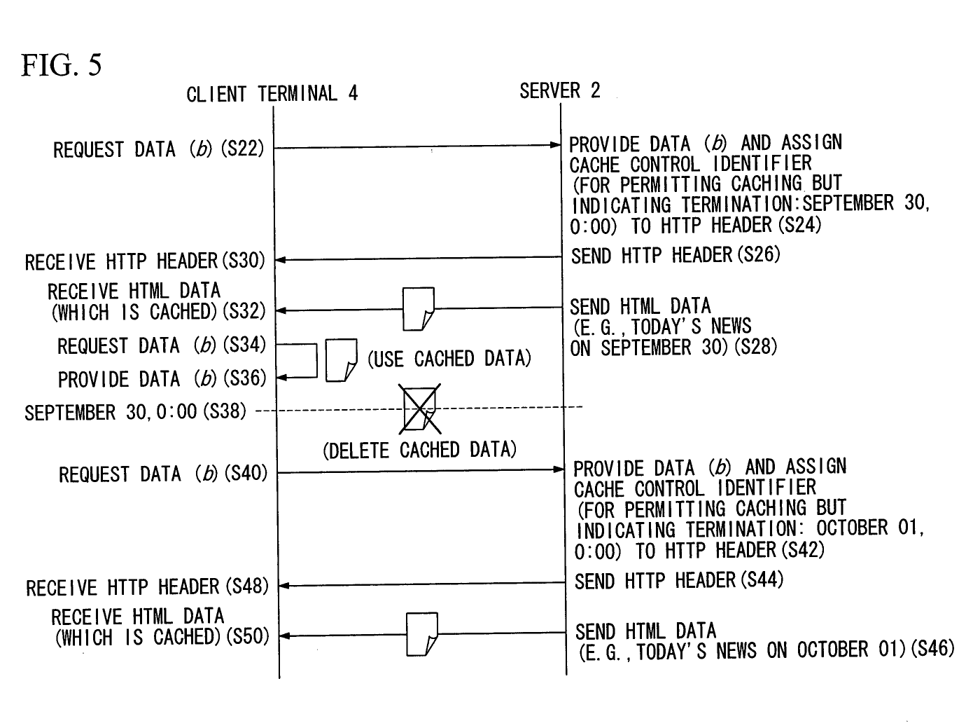

FIG. 5 relates to a case in which a service content for today's news (i.e., data b) is requested. When the client terminal 4 sends a service content request signal for data b from the communication section 3 (see step S22), the server 2, which receives the request signal, reads out data b, which has been stored for the category K2 in the contents storage section 10, and converts the data into HTML data.

In this process, cache identifier B (which indicates the termination of the cache: September 30, 0:00 AM) corresponding to the category K2 is assigned to the HTTP header of the HTML data by the cache identifier providing section 12 (see step S24). In steps S26 and S28, the HTTP header, to which the cache identifier B has been appended, and the HTML data of data b are sent to the client terminal 4.

In steps S30 and S32, the client terminal 4 receives the HTTP header and the HTML data via the communication section 3. As explained above, the HTML data of data b is then output to the output section 15 (i.e., data is displayed or voice data is output). The cache state managing section 17 performs management of the cache state according to the cache identifier B appended to the received HTTP header. In this case, the HTML data of data b is stored in the RAM of the cache section 14 until the cache time expires (i.e., the time reaches the defined termination of the caching). Therefore, even when the image on the screen of the output section 15 is changed by an operation of the passenger, or the like, the HTML data of data b is stored in the RAM of the cache section 14.

Before the cache time expires, when the service content request signal for data b is again input into the client terminal 4 (see step S34), data which has been stored in the cache section 14 (i.e., data b) is output to the output section 15 (see step S36) without sending the request signal to the server 2.

When the cache time expires (in this case, at 0:00 AM on September 30) (see step S38), the data which has been stored in the RAM of the cache section 14 (i.e., data b) is deleted by the cache state managing section 17. After the deletion, when the access request for data b is again issued (see step S40), the client terminal 4 sends the service content request signal to the server 2. Similar to the above-explained process, the server 2 assigns the cache identifier B to the HTTP header (which indicates the termination of the cache: October 01, 0:00 AM) (see step S42) and sends the HTTP header and the HTML data of data b (see steps S44 and S46). The client terminal 4 receives these data (see steps S48 and S50) and stores the HTML data of data b in the RAM of the cache section 14 until the cache time expires, similar to the above-explained process.

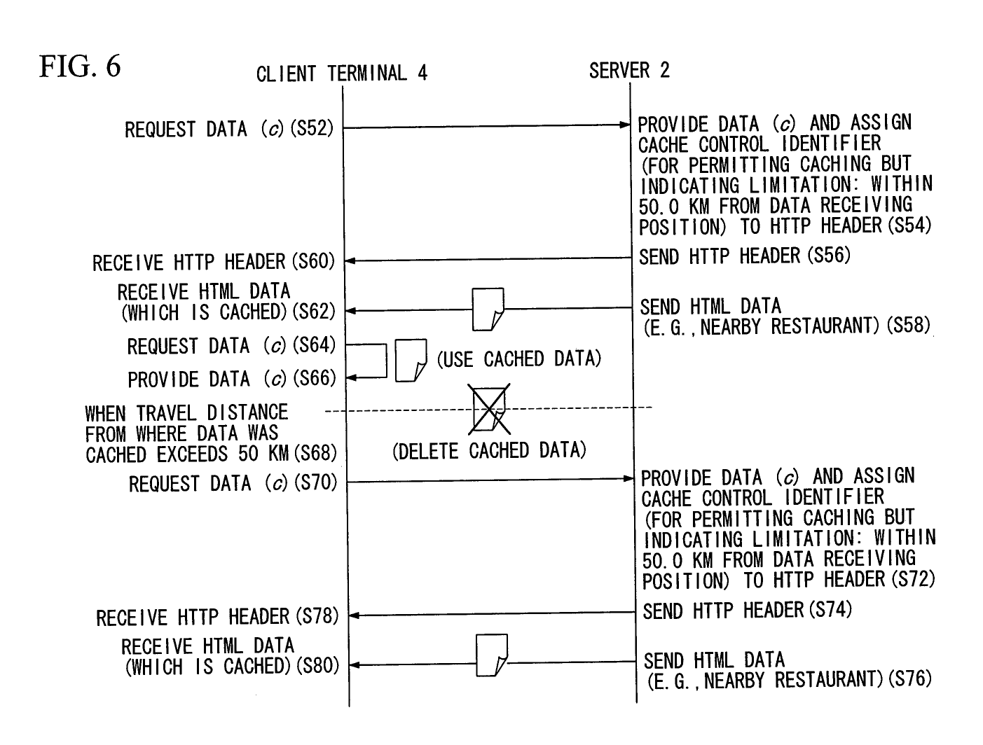

FIG. 6 relates to a case in which a service content for a nearby restaurant (i.e., data c) is requested. When the client terminal 4 sends a service content request signal for data c from the communication section 3 (see step S52), the server 2, which receives the request signal, reads out data c which has been stored for the category K3 in the contents storage section 10 and converts the data into HTML data.

In this process, cache identifier C (which indicates cache storage while, for example, the travel distance (from the data receiving position) is 50 km or less) corresponding to the category K3 is assigned to the HTTP header of the HTML data by the cache identifier providing section 12 (see step S54). In steps S56 and S58, the HTTP header, to which the cache identifier C has been appended, and the HTML data for data c are sent to the client terminal 4.

In steps S60 and S62, the client terminal 4 receives the HTTP header and the HTML data via the communication section 3. As explained above, the HTML data of data c is then output to the output section 15 (i.e., data is displayed or voice data is output). The cache state managing section 17 performs management of the cache state according to the cache identifier C appended to the received HTTP header. In this case, the travel distance (or displacement) of the vehicle is determined according to the output of the vehicle travel distance determining section 21, and the HTML data of data c is stored in the RAM of the cache section 14 until the condition for the caching is no longer satisfied (i.e., until the travel distance exceeds a predetermined value). Therefore, even when the image on the screen of the output section 15 is changed by an operation of the passenger, or the like, the HTML data of data c is stored in the RAM of the cache section 14.

Before the condition for the caching is no longer satisfied, when the service content request signal for data c is again input into the client terminal 4 (see step S64), data which has been stored in the cache section 14 (i.e., data c) is output to the output section 15 (see step S66) without sending the request signal to the server 2.

When the condition for the caching is no longer satisfied (in this case, when the travel distance from the position where the data was cached (into the RAM) exceeds 50 km) (see step S68), the data which has been stored in the RAM of the cache section 14 (i.e., data c) is deleted by the cache state managing section 17. After the deletion, when the access request for data c is again issued (see step S70), the client terminal 4 sends the service content request signal to the server 2. Similar to the above-explained process, the server 2 assigns the cache identifier C to the HTTP header (see step S72) and sends the HTTP header and the HTML data of data c (see steps S74 and S76). The client terminal 4 receives these data (see steps S78 and S80) and stores the HTML data of data c in the RAM of the cache section 14 until the condition for the caching is no longer satisfied, similar to the above-explained process.

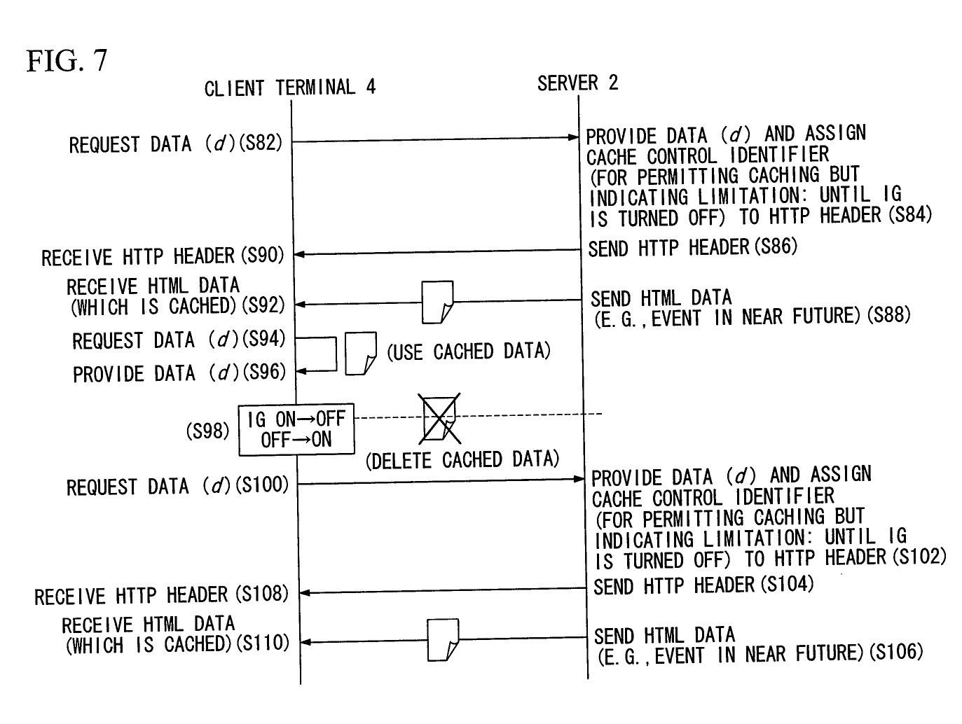

FIG. 7 relates to a case in which a service content for an event in the near future (i.e., data d) is requested. When the client terminal 4 sends a service content request signal for data d from the communication section 3 (see step S82), the server 2, which receives the request signal, reads out data d, which has been stored for the category K4 in the contents storage section 10, and converts the data into HTML data.

In this process, cache identifier D (which indicates that the caching state is continued until the ignition switch (IG) is turned off) corresponding to the category K4 is assigned to the HTTP header of the HTML data by the cache identifier providing section 12 (see step S84). In steps S86 and S88, the HTTP header, to which the cache identifier D has been appended, and the HTML data for data d are sent to the client terminal 4.

In steps S90 and S92, the client terminal 4 receives the HTTP header and the HTML data via the communication section 3. As explained above, the HTML data of data d is then output to the output section 15 (i.e., data is displayed or voice data is output). The cache state managing section 17 performs management of the cache state according to the cache identifier D appended to the received HTTP header. In this case, the HTML data of data d is stored in the RAM of the cache section 14 until the condition for the caching is no longer satisfied (i.e., until the IG is turned off). Therefore, even when the image on the screen of the output section 15 is changed by an operation of the passenger, or the like, the HTML data of data d is stored in the RAM of the cache section 14.

Before the condition for the caching is no longer satisfied, when the service content request signal for data d is again input into the client terminal 4 (see step S94), data which has been stored in the cache section 14 (i.e., data d) is output to the output section 15 (see step S96) without sending the request signal to the server 2.

When the condition for the caching is no longer satisfied (in this case, when the IG is turned off) (see step S98), the data which has been stored in the RAM of the cache section 14 (i.e., data d) is deleted by the cache state managing section 17. After the deletion, when the access request for data d is again issued (see step S100), the client terminal 4 sends the service content request signal to the server 2. Similar to the above-explained process, the server 2 assigns the cache identifier D to the HTTP header (see step S102) and sends the HTTP header and the HTML data for data d (see steps S104 and S106). The client terminal 4 receives these data (see steps S108 and S110) and stores the HTML data of data d in the RAM of the cache section 14 until the condition for the caching is no longer satisfied, similar to the above-explained process.

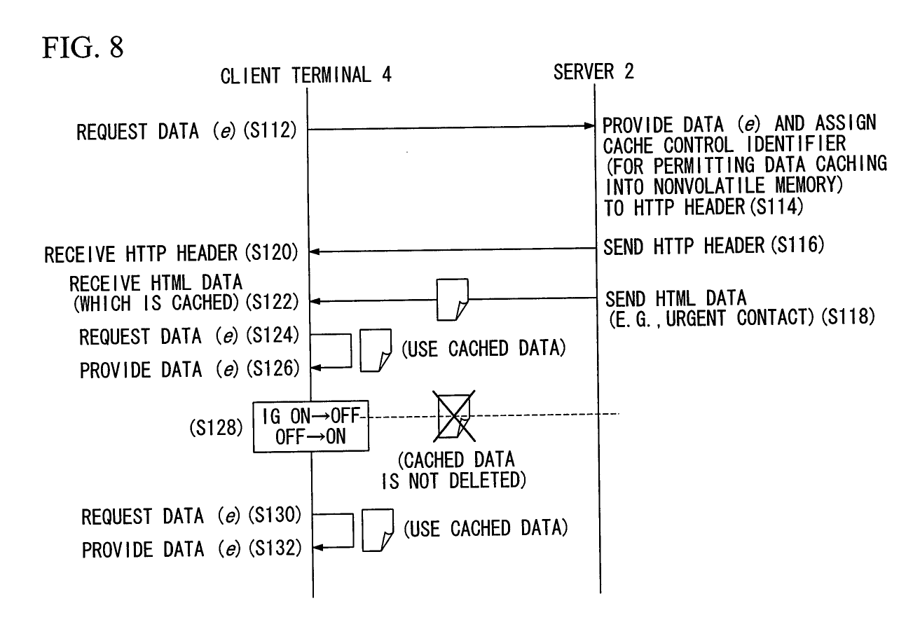

FIG. 8 relates to a case in which a service content for urgent contact (i.e., data e) is requested. When the client terminal 4 sends a service content request signal for data e from the communication section 3 (see step S112), the server 2, which receives the request signal, reads out data e, which has been stored for the category K5 in the contents storage section 10, and converts the data into HTML data.

In this process, cache identifier E (which indicates that data writing to nonvolatile memory is permitted) corresponding to the category K5 is assigned to the HTTP header of the HTML data by the cache identifier providing section 12 (see step S114). In steps S116 and S118, the HTTP header, to which the cache identifier E has been appended, and the HTML data for data e are sent to the client terminal 4.

In steps S120 and S122, the client terminal 4 receives the HTTP header and the HTML data via the communication section 3. As explained above, the HTML data for data e is then output to the output section 15 (i.e., data is displayed or voice data is output). The cache state managing section 17 performs management of the cache state according to the cache identifier E appended to the received HTTP header. In this case, the HTML data of data e is stored in the ROM of the cache section 14. Therefore, even when the image on the screen of the output section is changed by an operation of the passenger, or the like, the HTML data of data e is stored in the ROM of the cache section 14.

When the service content request signal for data e is again input into the client terminal 4 (see step S124), data which has been stored in the cache section 14 (i.e., data e) is output to the output section 15 (see step S126) without sending the request signal to the server 2.

In this case, the HTML data for data e is stored in the ROM of the cache section 14. Therefore, even when the IG is turned from the on-state to the off-state (see step S128), the HTML data of data d is stored without being deleted.

Accordingly, when the IG is again turned on and the access request for data e is again input into the client terminal 4 (see step S130), data which has been stored in the cache section 14 (i.e., data e) is output to the output section 15 (see step S132) without sending the request signal to the server 2.

As for the above-explained data b to e, after data of each service content stored in the cache section 14 is output from the cache section 14, if a data access request is again issued according to the intention of the passenger, data access to the server may be performed.

The above-explained service contents are examples for explaining features of each cache state, and the service contents in the present invention are not limited. That is, the service contents may be suitably defined in accordance with the characteristics of each cache state.

What is claimed is:

1. A server of a client-server vehicle data communication system, comprising:
a service contents managing section for managing a plurality of service contents to be provided to a client terminal of a vehicle, wherein the service contents managing section includes a cache identifier providing section for assigning each service content provided to the client terminal a cache identifier which indicates a data cache state in the client terminal, so as to manage the data cache state of the service content.

2. A server as claimed in claim 1, wherein the assigned cache identifier is selected from the group consisting of:
an identifier for indicating that the service content is not stored in the client terminal;
an identifier for indicating that the service content is temporarily stored until an engine of the vehicle is stopped;
an identifier for indicating that the service content is stored even after the engine of the vehicle is stopped;
an identifier for indicating that the service content is stored while a travel distance of the vehicle from where the vehicle obtained the service content is within a predetermined value; and
an identifier for indicating that the service content is stored from when the vehicle obtains the service content until a predetermined time has elapsed.

3. A client terminal using a server as claimed in claim 1 of a client-server vehicle data communication system, said client terminal comprising:
a cache state managing section for managing the data cache state of the service content provided from the server, according to the cache identifier assigned to the service content.

4. A client terminal using a server as claimed in claim 2 of a client-server vehicle data communication system, said client terminal comprising:
a cache state managing section for managing the data cache state of the service content provided from the server, according to the cache identifier assigned to the service content.

5. A client terminal as claimed in claim 3, further comprising:
a request sending section for sending a request signal for the service content to the server, where the service content is provided from the server when the request signal is received by the server;
the cache identifier indicates a condition for caching of the service content; and
when a request for the service content is again issued in the client terminal while the condition for the caching is satisfied and the service content is cached in a memory of the client terminal, the service content in the memory is read out without sending the request signal for the service content to the server.

6. A client-server vehicle data communication system comprising:
a server as claimed in claim 1; and
a client terminal which uses the server and includes a cache state managing section for managing the data cache state of the service content provided from the server, according to the cache identifier assigned to the service content.

7. A client-server vehicle data communication system comprising:
a server as claimed in claim 2; and
a client terminal which uses the server and includes a cache state managing section for managing the data cache state of the service content provided from the server, according to the cache identifier assigned to the service content.

8. A client-server vehicle data communication system as claimed in claim 6, wherein:
the service content is provided from the server to the client terminal when a request signal for the service content is sent from the client terminal to the server;
the cache identifier indicates a condition for caching of the service content; and
when a request for the service content is again issued in the client terminal while the condition for the caching is satisfied and the service content is cached in a memory of the client terminal, the service content in the memory is read out without sending the request signal for the service content to the server.

9. A client terminal of a vehicle for obtaining data provided from a server which manages a plurality of service contents, said client terminal comprising:
a cache state managing section for recognizing a cache identifier which indicates a data cache state of data of a service content obtained from the server and managing the data cache state indicated by the cache identifier.

10. A client terminal as claimed in claim 9, wherein the cache identifier is selected from the group consisting of:
an identifier for indicating that the service content is not stored in the client terminal;
an identifier for indicating that the service content is temporarily stored until an engine of the vehicle is stopped;
an identifier for indicating that the service content is stored even after the engine of the vehicle is stopped;
an identifier for indicating that the service content is stored while a travel distance of the vehicle from where the vehicle obtained the service content is within a predetermined value; and
an identifier for indicating that the service content is stored from when the vehicle obtains the service content until a predetermined time has elapsed.
